(19) United States
(12) Patent Application Publication
(10) Pub. No.: US 2023/0314923 A1
(43) Pub. Date: Oct. 5, 2023

(54) LIGHT SOURCE APPARATUS AND PROJECTOR

(71) Applicant: SEIKO EPSON CORPORATION, Tokyo (JP)

(72) Inventors: Junichi SUZUKI, Matsumoto-shi (JP); Kazuya FURUTA, Matsumoto-shi (JP)

(21) Appl. No.: 18/192,844

(22) Filed: Mar. 30, 2023

(30) Foreign Application Priority Data
Mar. 30, 2022 (JP) 2022-055310

(51) Int. Cl. G03B 21/20

(52) U.S. Cl. CPC G03B 21/204; G03B 21/2066

(57) ABSTRACT

A light source apparatus according to an aspect of the present disclosure includes a light emitter that outputs first light having a first wavelength band, a wavelength conversion member that contains a phosphor, and a reflection member that reflects the first light that enters the wavelength conversion member. The wavelength conversion member has a first surface and a second surface located at the sides opposite from each other in a first direction, and a third surface and a fourth surface located at the sides opposite from each other in a second direction that intersects with the first direction. An activator contained in the phosphor has a concentration required to absorb the first light by an amount smaller than 98% of the amount of the incident first light in the path along which the first light incident via the third surface travels to the fourth surface.

The present application is based on, and claims priority from JP Application Serial Number 2022-055310, filed Mar. 30, 2022, the disclosure of which is hereby incorporated by reference herein in its entirety.

### BACKGROUND

### 1. Technical Field

The present disclosure relates to a light source apparatus and a projector.

### 2. Related Art

As a light source apparatus used in a projector, there has been a proposed light source apparatus using fluorescence emitted from a phosphor when the phosphor is irradiated with excitation light outputted from a light emitter.

JP-T-2017-526103 discloses a light source apparatus including a solid-state light source that outputs excitation light and a wavelength conversion member that converts the excitation light into fluorescence. JP-T-2017-526103 describes that the concentration of the activator contained in the phosphor is typically so selected that the entire excitation light is absorbed by the activator in the path along which the excitation light travels from the light incident surface to the surface opposite therefrom, for example, 98% of the excitation light is absorbed under specific conditions. JP-T-2017-526103 further describes as a unique feature of the invention described therein that the wavelength conversion efficiency is further increased by increasing the concentration of the activator to at least three times the concentration required for the activator to absorb 98% of the excitation light.

In the wavelength conversion member of the light source apparatus disclosed in JP-T-2017-526103, however, when the excitation light reaches the surface opposite from the light incident surface, almost all the excitation light is converted into the fluorescence by the activator. In the wavelength conversion member, when a reflection member is disposed at the surface opposite from the light incident surface, on which the excitation light is incident, almost all the light reflected off the reflection member is the fluorescence, into which the excitation light has been converted. There is therefore a risk that a variety of problems occur, such as the activator's excess reabsorption of the reflected fluorescence.

### SUMMARY

To solve the problems described above, a light source apparatus according to an aspect of the present disclosure includes a light emitter that outputs first light having a first wavelength band, a wavelength conversion member that contains a phosphor and converts the first light outputted from the light emitter into second light having a second wavelength band different from the first wavelength band, and a reflection member that reflects the first light that enters the wavelength conversion member. The wavelength conversion member has a first surface and a second surface located at sides opposite from each other in a first direction, and a third surface and a fourth surface located at sides opposite from each other in a second direction that intersects with the first direction. The second light exits via the first surface. The first light outputted from the light emitter enters the wavelength conversion member via the third surface. The reflection member is provided so as to face the fourth surface. An activator contained in the phosphor has a concentration required to absorb the first light by an amount smaller than 98% of an amount of the incident first light in a path along which the first light incident via the third surface travels to the fourth surface.

A projector according to another aspect of the present disclosure includes the light source apparatus according to the aspect of the present disclosure, a light modulator that modulates light outputted from the light source apparatus and containing the second light in accordance with image information, and a projection optical apparatus that projects the light modulated by the light modulator.

### BRIEF DESCRIPTION OF THE DRAWINGS

FIG. 1 is a schematic configuration diagram of a projector according to a first embodiment.

FIG. 2 is a schematic configuration diagram of a first illuminator in the first embodiment.

FIG. 3 is a graph showing the relationship between the excitation light absorptance and the amount of emitted fluorescence.

FIG. 4 is a schematic configuration diagram of a first illuminator in a second embodiment.

FIG. 5 is a cross-sectional view of a light source apparatus taken along the line V-V in FIG. 4.

### DESCRIPTION OF EXEMPLARY EMBODIMENTS

### First Embodiment

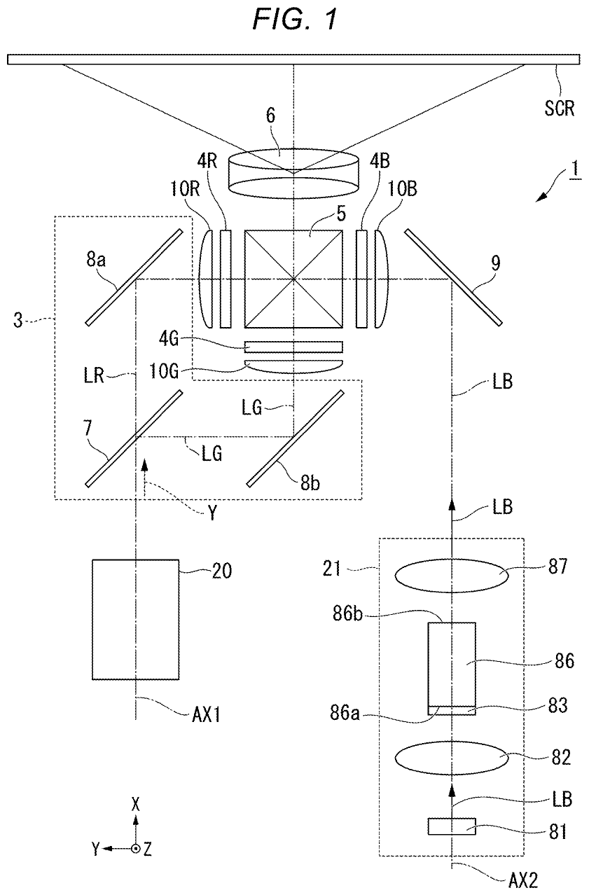

A first embodiment of the present disclosure will be described below with reference to FIGS. 1 to 3.

A projector according to the present embodiment is an example of a projector using liquid crystal panels as light modulators.

In the following drawings, components may be drawn at different dimensional scales for clarification of each of the components.

FIG. 1 shows a schematic configuration of a projector 1 according to the present embodiment.

The projector 1 according to the present embodiment is a projection-type image display apparatus that displays a color image on a screen (projection receiving surface) SCR, as shown in FIG. 1. The projector 1 includes three light modulators corresponding to three types of color light, red light LR, green light LG, and blue light LB.

The projector 1 includes a first illuminator 20, a second illuminator 21, a color separation system 3, light modulators 4R, 4G, and 4B, a light combiner 5, and a projection optical apparatus 6.

The first illuminator 20 outputs yellow fluorescence Y toward the color separation system 3. The second illuminator 21 outputs the blue light LB toward the light modulator 4B. Detailed configurations of the first illuminator 20 and the second illuminator 21 will be described later.

The following description with reference to the drawings will be made by using an XYZ orthogonal coordinate system as required. The axis Z is an axis extending along the upward-downward direction of the projector 1. The axis X is an axis parallel to an optical axis AX1 of the first illuminator 20 and an optical axis AX2 of the second illuminator 21. The axis Y is an axis perpendicular to the axes X and Z. The optical axis AX1 of the first illuminator 20 is the center axis of the fluorescence Y outputted from the first illuminator 20. The optical axis AX2 of the second illuminator 21 is the center axis of the blue light LB outputted from the second illuminator 21.

The color separation system 3 separates the yellow fluorescence Y outputted from the first illuminator 20 into the red light LR and the green light LG. The color separation system 3 includes a dichroic mirror 7, a first reflection mirror 8a, and a second reflection mirror 8b.

The dichroic mirror 7 separates the fluorescence Y into the red light LR and the green light LG. The dichroic mirror 7 transmits the red light LR and reflects the green light LG. The second reflection mirror 8b is disposed in the optical path of the green light LG. The second reflection mirror 8b reflects the green light LG reflected off the dichroic mirror 7 toward the light modulator 4G. The first reflection mirror 8a is disposed in the optical path of the red light LR. The first reflection mirror 8a reflects the red light LR having passed through the dichroic mirror 7 toward the light modulator 4R.

On the other hand, the blue light LB outputted from the second illuminator 21 is reflected off a reflection mirror 9 toward the light modulator 4B.

The configuration of the second illuminator 21 will be described below.

The second illuminator 21 includes a light source section 81, a focusing lens 82, a diffuser plate 83, a rod lens 86, and a relay lens 87. The light source section 81 is formed of at least one semiconductor laser. The light source section 81 outputs the blue light LB formed of laser light. The light source section 81 is not necessarily formed of a semiconductor laser and may be formed of an LED that outputs blue light.

The focusing lens 82 is formed of a convex lens. The focusing lens 82 causes the blue light LB outputted from the light source section 81 to be incident on the diffuser plate 83 with the blue light LB substantially focused thereon. The diffuser plate 83 diffuses the blue light LB having exited out of the focusing lens 82 into blue light LB diffused by a predetermined degree to generate blue light LB having a substantially uniform light orientation distribution similar to that of the fluorescence Y outputted from the first illuminator 20. The diffuser plate 83 is, for example, a ground glass plate made of optical glass.

The blue light LB diffused by the diffuser plate 83 enters the rod lens 86. The rod lens 86 has a quadrangular columnar shape extending along the optical axis AX2 of the second illuminator 21. The rod lens 86 has one end that is a light incident end surface 86a and the other end that is a light exiting end surface 86b. The diffuser plate 83 is fixed to the light incident end surface 86a of the rod lens 86 via an optical adhesive (not shown). It is desirable that the refractive index of the diffuser plate 83 matches as much as possible with the refractive index of the rod lens 86.

The blue light LB propagates through the interior of the rod lens 86 while being totally reflected therein and exits via the light exiting end surface 86b with the illuminance distribution uniformity of the blue light LB increased. The blue light LB having exited out of the rod lens 86 enters the relay lens 87. The relay lens 87 causes the blue light LB having the illuminance distribution uniformity increased by the rod lens 86 to be incident on the reflection mirror 9.

The light exiting end surface 86b of the rod lens 86 has a rectangular shape substantially similar to the shape of an image formation region of the light modulator 4B. The blue light LB having exited out of the rod lens 86 is thus efficiently incident on the image formation region of the light modulator 4B.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers (not shown) are disposed at the light incident and exiting sides of each of the liquid crystal panels. The polarizers each transmit only linearly polarized light polarized in a specific direction.

A field lens 10R is disposed at the light incident side of the light modulator 4R. A field lens 10G is disposed at the light incident side of the light modulator 4G. A field lens 10B is disposed at the light incident side of the light modulator 4B. The field lens 10R parallelizes the chief ray of the red light LR to be incident on the light modulator 4R. The field lens 10G parallelizes the chief ray of the green light LG to be incident on the light modulator 4G. The field lens 10B parallelizes the chief ray of the blue light LB to be incident on the light modulator 4B.

The light combiner 5 receives the image light outputted from the light modulator 4R, the image light outputted from the light modulator 4G, and the image light outputted from the light modulator 4B, combines the image light corresponding to the red light LR, the image light corresponding to the green light LG, and the image light corresponding to the blue light LB with one another, and outputs the combined image light toward the projection optical apparatus 6. The light combiner 5 is, for example, a cross dichroic prism.

The projection optical apparatus 6 is formed of a plurality of projection lenses. The projection optical apparatus 6 enlarges the combined image light from the light combiner 5 and projects the enlarged image light toward the screen SCR. An image is thus displayed on the screen SCR.

The configuration of the first illuminator 20 will be described below.

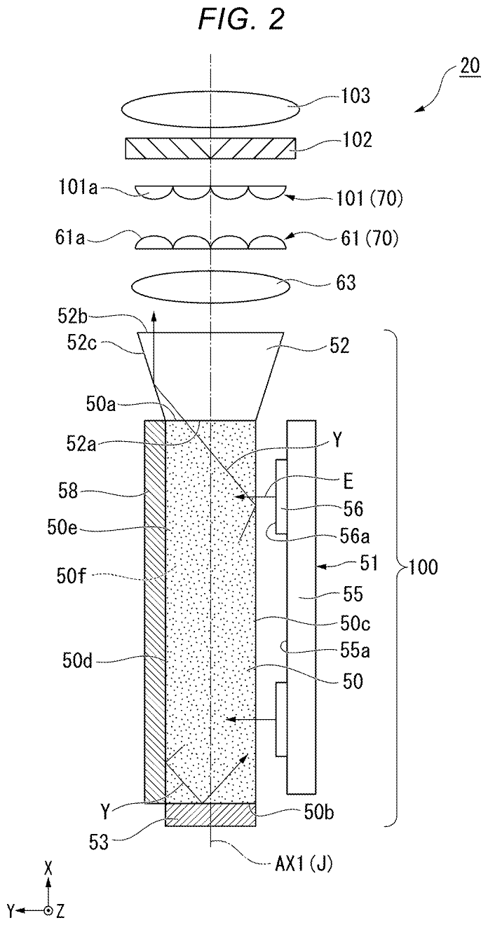

FIG. 2 is a schematic configuration diagram of the first illuminator 20.

The first illuminator 20 includes a light source apparatus 100, a parallelizing system 63, an optical integration system 70, a polarization converter 102, and a superimposing system 103, as shown in FIG. 2.

The light source apparatus 100 includes a wavelength conversion member 50, a light source section 51, an angle conversion member 52, a first mirror 58, and a second mirror 53. The light source section 51 includes a substrate 55 and light emitters 56. The first mirror 58 in the present embodiment corresponds to the reflection member in the claims.

The wavelength conversion member 50 has a quadrangular columnar shape extending in the axis-X direction and has six surfaces. The sides of the wavelength conversion member 50 that extend in the axis-X direction are longer than the sides of the wavelength conversion member 50 that extend in the axis-Y direction and the sides thereof that extend in the axis-Z direction. Therefore, the axis-X direction corresponds to the longitudinal direction of the wavelength conversion member 50. The length of the sides extending in the axis-Y direction is equal to the length of the sides extending in the axis-Z direction. That is, the wavelength conversion member 50 has a square cross-sectional shape taken along a plane perpendicular to the axis-X direction. The wavelength conversion member 50 may instead have an oblong cross-sectional shape taken along a plane perpendicular to the axis-X direction.

The wavelength conversion member 50 has a first surface 50a, a second surface 50b, a third surface 50c, a fourth surface 50d, a fifth surface 50e, and a sixth surface 50f. The first surface 50a and the second surface 50b intersect with the longitudinal direction (axis-X direction) of the wavelength conversion member 50 and are located at the sides opposite from each other. The third surface 50c and the fourth surface 50d intersect with the first surface 50a and the second surface 50b, and are located at the sides opposite from each other in the axis-Y direction in an imaginary plane perpendicular to the longitudinal direction. The fifth surface 50e and the sixth surface 50f intersect with the third surface 50c and the fourth surface 50d, and are located at the sides opposite from each other in the axis-Z direction in an imaginary plane perpendicular to the longitudinal direction. In the following description, the third surface 50c, the fourth surface 50d, the fifth surface 50e, and the sixth surface 50f may be referred to as side surfaces. The axis-X direction in the present embodiment corresponds to the first direction in the claims. The axis-Y direction in the present embodiment corresponds to the second direction in the claims. The axis-Z direction in the present embodiment corresponds to the third direction in the claims.

The wavelength conversion member 50 at least contains a phosphor and converts excitation light E having a first wavelength band into the fluorescence Y having a second wavelength band different from the first wavelength band. The excitation light E enters the wavelength conversion member 50 via the third surface 50c. The fluorescence Y is guided through the interior of the wavelength conversion member 50, and then exits via the first surface 50a. The excitation light E in the present embodiment corresponds to the first light in the claims. The fluorescence Y in the present embodiment corresponds to the second light in the claims.

The wavelength conversion member 50 contains a ceramic phosphor formed of a polycrystal phosphor that converts the excitation light E in terms of wavelength into the fluorescence Y. The second wavelength band of the fluorescence Y is, for example, a yellow wavelength band ranging from 490 to 750 nm. That is, the fluorescence Y is yellow fluorescence containing a red light component and a green light component.

The wavelength conversion member 50 may contain a single crystal phosphor in place of a polycrystal phosphor. The wavelength conversion member 50 may instead be made of fluorescent glass. Still instead, the wavelength conversion member 50 may be formed of a binder which is made of glass or resin and in which a large number of phosphor particles are dispersed. The wavelength conversion member 50 made of any of the materials described above converts the excitation light E into the fluorescence Y.

Specifically, the material of the wavelength conversion member 50 contains, for example, an yttrium-aluminum-garnet-based (YAG-based) phosphor. The phosphor further contains an activator that serves as a light emission center. Consider YAG:Ce, which contains cerium (Ce) as an activator, by way of example, and the wavelength conversion member 50 is made, for example, of a material produced by mixing raw powder materials containing Y₂O₃, Al₂O₃, CeO₃, and other constituent elements with one another and causing the mixture to undergo a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method.

The activator, such as cerium, contained in the phosphor desirably has a concentration required to absorb the excitation light E by an amount smaller than 98% of the amount of incident excitation light E, preferably smaller than 98% but greater than 30%, in the path along which the excitation light E incident via the third surface 50c travels to the fourth surface 50d. Furthermore, the activator more desirably has a concentration that allows the activator to absorb the excitation light E by an amount smaller than or equal to 92% but greater than or equal to 40% of the amount of incident excitation light E in the path described above. The reason for setting the aforementioned ranges of the concentration of the activator will be described later.

The light source section 51 includes the light emitters 56 each having a light emitting surface 56a, via which the excitation light E having the first wavelength band exits. The light emitters 56 are each formed, for example, of a light emitting diode (LED). The light emitting surface 56a of each of the light emitters 56 faces the third surface 50c of the wavelength conversion member 50, and the light emitters 56 each output the excitation light E via the light emitting surface 56a toward the third surface 50c. The first wavelength band is, for example, a blue-violet wavelength band ranging from 400 to 480 nm and has a peak wavelength of, for example, 445 nm. The light source section 51 is thus provided so as to face one of the four side surfaces, which extend along the longitudinal direction of the wavelength conversion member 50.

The substrate 55 supports the light emitters 56. The light emitters 56 are provided at one surface 55a of the substrate 55. In the present embodiment, the light source section 51 is formed of the light emitters 56 and the substrate 55 and may further include a light guiding plate, a diffuser plate, a lens, and other optical members. In the present embodiment, two light emitters 56 are used, but the number of light emitters 56 is not limited to a specific number.

The first mirror 58 is provided so as to face the fourth surface 50d of the wavelength conversion member 50. The first mirror 58 is desirably in contact with the fourth surface 50d of the wavelength conversion member 50 without an air layer or any other portion interposed therebetween. The first mirror 58 reflects the excitation light E having entered the wavelength conversion member 50. The reflectance of the first mirror 58 is desirably as high as possible. Specifically, the reflectance of the first mirror 58 is desirably higher than or equal to 75%, more desirably, higher than or equal to 90%. The first mirror 58 is made of a metal material having high reflectance, for example, aluminum or silver. The first mirror 58 further desirably has thermal conductivity higher than the thermal conductivity of the wavelength conversion member. The first mirror 58 is not necessarily made of a metal material and may instead be formed of a dielectric multilayer film.

The second mirror 53 is provided so as to face the second surface 50b of the wavelength conversion member 50. The second mirror 53 reflects the fluorescence Y having been guided through the interior of the wavelength conversion member 50 and having reached the second surface 50b. The second mirror 53 is formed of a metal film or a dielectric multilayer film formed at the second surface 50b of the wavelength conversion member 50.

In the first illuminator 20, when the excitation light E outputted from the light source section 51 enters the wavelength conversion member 50, the phosphor contained in the wavelength conversion member 50 is excited, and the fluorescence Y is emitted from random light emission points. The fluorescence Y travels omnidirectionally from the random light emission points, and the fluorescence Y traveling toward the four side surfaces 50c, 50d, 50e, and 50f are totally reflected off the side surfaces 50c, 50d, 50e, and 50f and travels toward the first surface 50a or the second surface 50b in the process of repeated total reflection at a plurality of locations. The fluorescence Y traveling toward the first surface 50a enters the angle conversion member 52. The fluorescence Y traveling toward the second surface 50b is reflected off the second mirror 53 and travels toward the first surface 50a.

Out of the excitation light E having entered the wavelength conversion member 50, part of the excitation light E, the part not having been used to excite the phosphor, is reflected off members around the wavelength conversion member 50, including the light emitters 56 of the light source section 51, or the second mirror 53 provided at the second surface 50b. The part of the excitation light E is therefore confined in the wavelength conversion member 50 and reused.

The angle conversion member 52 is provided at the light exiting side of the first surface 50a of the wavelength conversion member 50. The angle conversion member 52 is formed, for example, of a tapered rod. The angle conversion member 52 has a light incident surface 52a, on which the fluorescence Y having exited out of the wavelength conversion member 50 is incident, a light exiting surface 52b, via which the fluorescence Y exits, and a side surface 52c, which reflects the incident fluorescence Y toward the light exiting surface 52b.

The angle conversion member 52 has a truncated quadrangular pyramidal shape, and has a cross-sectional area that is perpendicular to an optical axis J and widens along the light traveling direction. The area of the light exiting surface 52b is therefore greater than the area of the light incident surface 52a. The optical axis J of the angle conversion member 52 is the axis passing through the centers of the light exiting surface 52b and the light incident surface 52a and parallel to the axis X. The optical axis J of the angle conversion member 52 coincides with the optical axis AX1 of the first illuminator 20.

The fluorescence Y having entered the angle conversion member 52 changes its orientation while traveling through the interior of the angle conversion member 52 in such a way that the direction of the fluorescence Y approaches the direction parallel to the optical axis J whenever the fluorescence Y is totally reflected off the side surface 52c. The angle conversion member 52 thus converts the exiting angle distribution of the fluorescence Y having exited via the first surface 50a of the wavelength conversion member 50. Specifically, the angle conversion member 52 makes the largest exiting angle of the fluorescence Y at the light exiting surface 52b smaller than the largest incident angle of the fluorescence Y at the light incident surface 52a.

In general, since the etendue of light specified by the product of the area of a light exiting region and the solid angle of the light (largest exiting angle) is preserved, the etendue of the fluorescence Y before the fluorescence Y passes through the angle conversion member 52 is preserved after the passage. The angle conversion member 52 has the configuration in which the area of the light exiting surface 52b is greater than the area of the light incident surface 52a, as described above. The angle conversion member 52 can therefore make the largest exiting angle of the fluorescence Y at the light exiting surface 52b smaller than the largest incident angle of the fluorescence Y incident on the light incident surface 52a from the viewpoint of the etendue preservation.

The angle conversion member 52 is fixed to the wavelength conversion member 50 via an optical adhesive (not shown) so that the light incident surface 52a faces the first surface 50a of the wavelength conversion member 50. That is, the angle conversion member 52 and the wavelength conversion member 50 are in contact with each other via the optical adhesive, and there is no air gap (air layer) between the angle conversion member 52 and the wavelength conversion member 50. If there is an air gap between the angle conversion member 52 and the wavelength conversion member 50, out of the fluorescence Y having reached the light incident surface 52a of the angle conversion member 52, the fluorescence Y incident on the light incident surface 52a at angles of incidence greater than the critical angle is totally reflected off the light incident surface 52a and cannot enter the angle conversion member 52. In contrast, when there is no air gap between the angle conversion member 52 and the wavelength conversion member 50, as in the present embodiment, the amount of fluorescence Y that cannot enter the angle conversion member 52 can be reduced. It is desirable from the viewpoint described above that the refractive index of the angle conversion member 52 match as much as possible with the refractive index of the wavelength conversion member 50.

The angle conversion member 52 may be a compound parabolic concentrator (CPC) in place of a tapered rod. The same effect is provided both when a CPC is used as the angle conversion member 52 and when a tapered rod is used as the angle conversion member 52. The light source apparatus 100 may not necessarily include the angle conversion member 52.

The parallelizing system 63, which is formed, for example, of a collimator lens, is provided between the light source apparatus 100 and the optical integration system 70. The parallelizing system 63 further narrows the angular distribution of the fluorescence Y having exited out of the angle conversion member 52 and causes the resultant fluorescence Y having a high degree of parallelism to enter the optical integration system 70. The parallelizing system 63 may not be provided when the fluorescence Y having exited out of the angle conversion member 52 has a sufficiently high degree of parallelism.

The optical integration system 70 includes a first lens array 61 and a second lens array 101. The optical integration system 70, along with the superimposing system 103, functions as an illumination homogenizing system that homogenizes the intensity distribution of the fluorescence Y outputted from the light source apparatus 100 at each of the light modulators 4R and 4G, which are illumination receiving regions. The fluorescence Y having exited out of the parallelizing system 63 enters the first lens array 61. The first lens array 61, along with the second lens array 101 provided at a position downstream from the light source apparatus 100, forms the optical integration system 70.

The first lens array 61 includes a plurality of first lenslets 61a. The plurality of first lenslets 61a are arranged in a matrix in a plane parallel to the plane YZ perpendicular to the optical axis AX1 of the first illuminator 20. The plurality of first lenslets 61a divide the fluorescence Y having exited out of the angle conversion member 52 into a plurality of sub-luminous fluxes. The first lenslets 61a each have a rectangular shape substantially similar to the shape of the image formation region of each of the light modulators 4R and 4G. The sub-luminous fluxes having exited out of the first lens array 61 are thus each efficiently incident on the image formation region of each of the light modulators 4R and 4G.

The fluorescence Y having exited out of the first lens array 61 travels toward the second lens array 101. The second lens array 101 is disposed so as to face the first lens array 61. The second lens array 101 includes a plurality of second lenslets 101a corresponding to the plurality of first lenslets 61a of the first lens array 61. The second lens array 101 along with the superimposing system 103 brings images of the plurality of first lenslets 61a of the first lens array 61 into focus in the vicinity of the image formation region of each of the light modulators 4R and 4G. The plurality of second lenslets 101a are arranged in a matrix in a plane parallel to the plane YZ perpendicular to the optical axis AX1 of the first illuminator 20.

In the present embodiment, the first lenslets 61a of the first lens array 61 and the second lenslets 101a of the second lens array 101 have the same size, and may instead have sizes different from each other. In the present embodiment, the first lenslets 61a of the first lens array 61 and the second lenslets 101a of the second lens array 101 are so disposed that the optical axes thereof coincide with each other, and may instead be so disposed that the optical axes thereof deviate from each other.

The polarization converter 102 converts the polarization directions of the fluorescence Y having exited out of the second lens array 101. Specifically, the polarization converter 102 converts the sub-luminous fluxes of the fluorescence Y into which the first lens array 61 divides the fluorescence Y and which exit out of the second lens array 101 into linearly polarized sub-luminous fluxes.

The polarization converter 102 includes polarization separation layers (not shown) that directly transmit one of the linearly polarized components contained in the fluorescence Y outputted from the light source apparatus 100 and reflect another one of the linearly polarized components in a direction perpendicular to the optical axis AX1, reflection layers (not shown) that reflect the other linearly polarized component reflected off the polarization separation layers in the direction parallel to the optical axis AX1, and retardation films (not shown) that convert the other linearly polarized component reflected off the reflection layers into the one linearly polarized component.

### Study on Concentration of Activator

The present inventor has studied the concentration of the activator contained in the phosphor in order to increase the amount of fluorescence outputted from the wavelength conversion member. To increase the wavelength conversion efficiency in the case where the excitation light is incident via one light incident surface of a wavelength conversion member, it is typically believed to introduce a large amount of activator into the phosphor to maximize the excitation light absorbed before the excitation light reaches the surface opposite from the light incident surface, as described in JP-T-2017-526103. The reason for this is that if a large amount of unabsorbed excitation light is present when the excitation light reaches the surface opposite from the light incident surface, the excitation light leaks out of the wavelength conversion member, resulting in a decrease in the wavelength conversion efficiency.

The present inventor has, however, conceived that increasing the concentration of the activator to absorb a large amount of excitation light causes the three problems below.

A first problem is that the activator also acts as a scattering source that scatters the light propagating through the interior of the wavelength conversion member. Therefore, a high concentration of the activator increases the amount of scattering of the excitation light and the fluorescence propagating through the interior of the wavelength conversion member, and the scattered excitation light and fluorescence are likely to leak via any of the side surfaces of the wavelength conversion member as compared with a case where the concentration of the activator is low. It is therefore difficult to cause a large amount of fluorescence to exit via the light exiting surface of the wavelength conversion member.

A second problem is a phenomenon that occurs, for example, when excitation light having a blue wavelength band is converted into fluorescence having a yellow wavelength band, and short-wavelength light components of the fluorescence, that is, light components close to the blue wavelength band out of those that form the yellow wavelength band are absorbed by the activator itself and further converted into long-wavelength light components. Therefore, when the concentration of the activator is high, the effect of the self-absorption of the fluorescence is not negligible, and the spectrum of the fluorescence shifts toward the longer wavelengths. As a result, fluorescence having a desired color tone is unlikely to be generated.

A third problem is that part of the energy of the excitation light absorbed by the activator is converted into the fluorescence while the remainder is converted into heat. Therefore, when the concentration of the activator is high, a large amount of heat is generated in the vicinity of the excitation light incident surface, and only a small amount of heat is generated in the vicinity of the surface opposite from the light incident surface. The temperature distribution inside the wavelength conversion member therefore becomes non-uniform, resulting in a decrease in the wavelength conversion efficiency, so that it is difficult to generate a large amount of fluorescence.

To solve the problems described above, the amount of activator may be reduced, but mere reduction in the amount of activator causes the problem of leakage of the unabsorbed excitation light out of the wavelength conversion member at the time when the excitation light reaches the surface opposite from the light incident surface, as described above. In view of the circumstances described above, the present inventor has conceived of the following technical idea: The amount of activator is reduced; and a reflection member is provided at the surface opposite from the light incident surface, so that the excitation light that has not been absorbed when reaching the opposite surface is reflected off the reflection member and absorbed again by the activator inside the wavelength conversion member. The reflection member described above corresponds to the first mirror in the present embodiment.

To verify the technical idea described above, the present inventor produced a plurality of test samples of the wavelength conversion member in which the activator has different concentrations, and conducted an experiment in which the amount of fluorescence outputted via the light exiting surface (first surface 50a in aforementioned embodiment) of the wavelength conversion member was measured on a sample basis.

The content of the experiment will be descried below.

The concentration of the activator needs to be determined as appropriate in accordance with a variety of parameters, such as the dimensions of the wavelength conversion member, the cooling efficiency at which the wavelength conversion member is cooled, and a desired fluorescence spectrum. In the experiment, the concentration of the activator in each of the samples is not expressed by the concentration value itself, but by the proportion of the excitation light absorbed until the excitation light incident via the light incident surface reaches the surface opposite from the light incident surface. That is, the excitation light absorptance corresponds to the concentration of the activator, so that the higher the concentration of the activator, the higher the excitation light absorptance, whereas the lower the concentration of the activator, the lower the excitation light absorptance. Hereinafter, in the path along which the excitation light incident via the light incident surface (third surface 50c in aforementioned embodiment) travels to the surface opposite from the light incident surface (fourth surface 50d in aforementioned embodiment), the ratio of the amount of absorbed excitation light to the amount of incident excitation light is defined as the excitation light absorptance.

To determine the excitation light absorptance, a light emitter was disposed at a position where the light emitter faced the third surface of the wavelength conversion member and a power meter was disposed at a position where the power meter faced the fourth surface of the wavelength conversion member. To determine the excitation light absorptance, the reflection member was not disposed at the position where the reflection member faced the fourth surface of the wavelength conversion member. A predetermined amount of excitation light was caused to enter the wavelength conversion member in the direction of a normal to the third surface, and the amount of the excitation light that exited via the fourth surface was measured with the power meter. Let P1 be the amount of excitation light incident via the third surface, and P2 be the amount of excitation light that exits via the fourth surface, and absorptance K (%) is determined by K=[(P1−P2)/P1]×100. On the other hand, to measure the fluorescence that exited out of the wavelength conversion member, a power meter including an integrating sphere was disposed at a position where the power meter faced the first surface of the wavelength conversion member, and the amount of fluorescence was measured with the power meter. The concentration of the activator contained in the wavelength conversion member can be measured by using an inductively coupled plasma (ICP) method.

As the specification of the wavelength conversion member, the wavelength conversion member was made of YAG:Ce, which contains cerium (Ce) as the activator, in accordance with the embodiment described above. The dimensions of the wavelength conversion member were set as follows: The length of the wavelength conversion member (distance between first and second surfaces) was 60 mm; the thickness of the wavelength conversion member (distance between third and fourth surfaces) was 1.2 mm; and the width of the wavelength conversion member (distance between fifth and sixth surfaces) was 1.6 mm.

As Example 1, a wavelength conversion member which having an excitation light absorptance of 75% and a reflection member's a reflectance of 90% was produced. As Example 2, a wavelength conversion member which having an excitation light absorptance of 75% and a reflection member's a reflectance of 75% was produced. As Example 3, a wavelength conversion member which having an excitation light absorptance of 50% and a reflection member's reflectance of 90% was produced. As Example 4, a wavelength conversion member which having an excitation light absorptance of 40% and a reflection member's reflectance of 90% was produced. As Example 5, a wavelength conversion member which having an excitation light absorptance of 20% and a reflection member's reflectance of 90% was produced. As Comparative Example to be compared with Examples 1 to 5, a wavelength conversion member having an excitation light absorptance of 98% and a reflection member's reflectance of 90% was produced.

Table 1 below shows the excitation light absorptance, the reflection member's reflectance, and the amount of emitted fluorescence on a sample basis. The amount of emitted fluorescence is expressed by a relative value provided that the amount of fluorescence emitted from the sample in Comparative Example is set at 100.

| | | | | | | Comp. |
|---|---|---|---|---|---|---|
| | Example 1 | Example 2 | Example 3 | Example 4 | Example 5 | Example |
| Excitation light | 75 | 75 | 50 | 40 | 20 | 98 |
| absorptance (%) | | | | | | |
| Reflection member's | 90 | 75 | 90 | 90 | 90 | 90 |
| reflectance (%) | | | | | | |
| Emitted fluorescence | 140 | 130 | 150 | 110 | 90 | 100 |
| (relative value) | | | | | | |

In Example 1, in which the excitation light absorptance was reduced to 75%, the amount of emitted fluorescence increased to 140 as compared with that in Comparative Example, as shown in Table 1. In Example 2, in which the reflection member's reflectance was reduced as compared with that in Example 1, the amount of emitted fluorescence was smaller than that in Example 1 but still increased to 130 as compared with that in Comparative Example. In Example 3, in which the excitation light absorptance was reduced to 50%, the amount of emitted fluorescence further increased to 150. In Example 4, in which the excitation light absorptance was reduced to 40%, the amount of emitted fluorescence decreased to 110, which is smaller than that in Example 3, but greater than that in Comparative Example. In Example 5, in which the excitation light absorptance was reduced to 20%, the amount of emitted fluorescence decreased to 90% as compared with the amount in Comparative Example.

In Examples 1 to 5, the degrees of the light scattering, the self-absorption, the non-uniform temperature distribution, and other harmful factors in the wavelength conversion member are reduced because the concentration of the activator is reduced so as to fall within the range from 75% to 20% in the path along which the excitation light incident via the third surface travels to the fourth surface in contrast to Comparative Example, in which the concentration of the activator is so high that substantially the entire incident excitation light is absorbed. Furthermore, the results shown in Table 1 demonstrate that the amount of emitted fluorescence can be increased in Examples 1 to 4. In Example 5, in which the concentration of the activator was reduced to 20%, it is inferred that the concentration of the activator was so low that the excitation light was not sufficiently absorbed and the amount of emitted fluorescence did not increase.

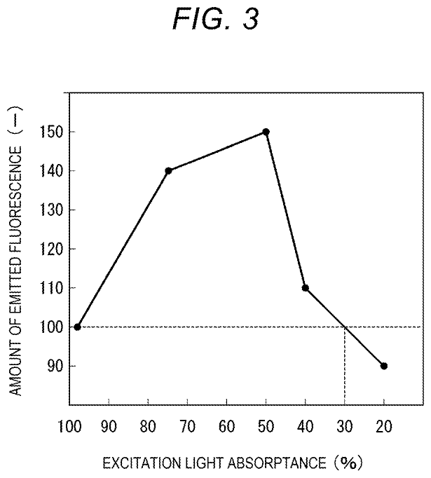

FIG. 3 shows the relationship in the form of a graph between the excitation light absorptance and the amount of emitted fluorescence in the samples except for Example 2, in which the reflectance of the reflection member was changed. In FIG. 3, the horizontal axis represents the excitation light absorptance (%), and the vertical axis represents the amount of emitted fluorescence (relative value).

The amount of emitted fluorescence tends to increase as the excitation light absorptance is reduced from 98%, as shown in FIG. 3. As far as the present experimental results are concerned, the amount of emitted fluorescence is maximized when the excitation light absorptance is set at 50%, and the amount of emitted fluorescence tends to decrease as the excitation light absorptance is reduced from 50%. The amount of emitted fluorescence becomes 100 when the excitation light absorptance is set at 30%, and the amount of emitted fluorescence is smaller than that in Comparative Example when the excitation light absorptance is reduced from 30%.

That is, when the concentration of the activator is so set that approximately half the incident excitation light is absorbed in the path along which the excitation light incident via the third surface travels to the fourth surface, it is inferred that a large amount of excitation light reflected off the fourth surface is absorbed before reaching the third surface again, and no excess excitation light is likely to exit out of the wavelength conversion member via the third surface, contributing to an increase in the amount of emitted fluorescence. It has therefore been demonstrated that when the activator has a concentration required to absorb the excitation light by an amount smaller than 98% but greater than 30% of incident excitation light in the path along which the excitation light incident via the third surface travels to the fourth surface, the amount of fluorescence that exits via the first surface of the wavelength conversion member can be increased as compared with that in a case where the activator has a concentration that causes absorption of substantially the entire incident excitation light.

### Effects of First Embodiment

The light source apparatus 100 according to the present embodiment includes the light emitters 56, which output the excitation light E, the wavelength conversion member 50, which contains a phosphor and converts the excitation light E outputted from the light emitters 56 into the fluorescence Y, and the first mirror 58, which reflects the excitation light E having entered the wavelength conversion member 50. The wavelength conversion member 50 has the first surface 50a and the second surface 50b, which are located at the sides opposite from each other in the axis-X direction, and the third surface 50c and the fourth surface 50d, which are located at the sides opposite from each other in the axis-Y direction. The fluorescence Y exits via the first surface 50a. The excitation light E outputted from the light emitters 56 enters the wavelength conversion member 50 via the third surface 50c. The first mirror 58 is provided so as to face the fourth surface 50d. The activator contained in the phosphor has a concentration required to absorb the excitation light by an amount smaller than 98% of the amount of incident excitation light E in the path along which the excitation light E incident via the third surface 50c travels to the fourth surface 50d.

As described above, the configuration described above, which is configured to further include the first mirror 58 as compared with the related-art configuration in which the activator has a concentration that causes absorption of substantially the entire incident excitation light, can still reduce the light scattering and the self-absorption in the wavelength conversion member 50.

Although unconfirmed in the experiment described above, the concentration of the activator is lower than that in the related art, so that an excess shift of the spectrum of the fluorescence Y toward the longer wavelengths can be suppressed, whereby fluorescence Y having a desired color tone can be generated.

In the light source apparatus 100 according to the present embodiment, the activator contained in the phosphor has a concentration required to absorb the excitation light by an amount greater than 30% of the amount of incident excitation light E in the path along which the excitation light E incident via the third surface 50c travels to the fourth surface 50d.

According to the configuration described above, the light scattering and the self-absorption in the wavelength conversion member 50 can be reduced in the configuration including the first mirror 58, whereby the amount of fluorescence Y light that exits via the first surface 50a of the wavelength conversion member 50 can be increased.

In the light source apparatus 100 according to the present embodiment, the first mirror 58 has a reflectance greater than or equal to 75%.

According to the configuration described above, the amount of fluorescence Y can be reliably increased within the range of the aforementioned concentration of the activator, as shown in Table 1.

In the light source apparatus 100 according to the present embodiment, the first mirror 58 has a reflectance greater than or equal to 90%.

According to the configuration described above, the amount of fluorescence Y can be more reliably increased within the range of the aforementioned concentration of the activator, as shown in Table 1.

In the light source apparatus 100 according to the present embodiment, the activator has a concentration required to absorb the excitation light by an amount smaller than or equal to 92% but greater than or equal to 40% of the amount of incident excitation light E in the path described above.

The configuration described above can provide a remarkable effect of increasing the amount of fluorescence Y by a value greater than or equal to 10% as compared with the amount achieved by the related-art configuration, as shown in FIG. 3.

The projector 1 according to the present embodiment, which includes the light source apparatus 100 according to the present embodiment, produces a bright image that excels in color reproducibility.

### Second Embodiment

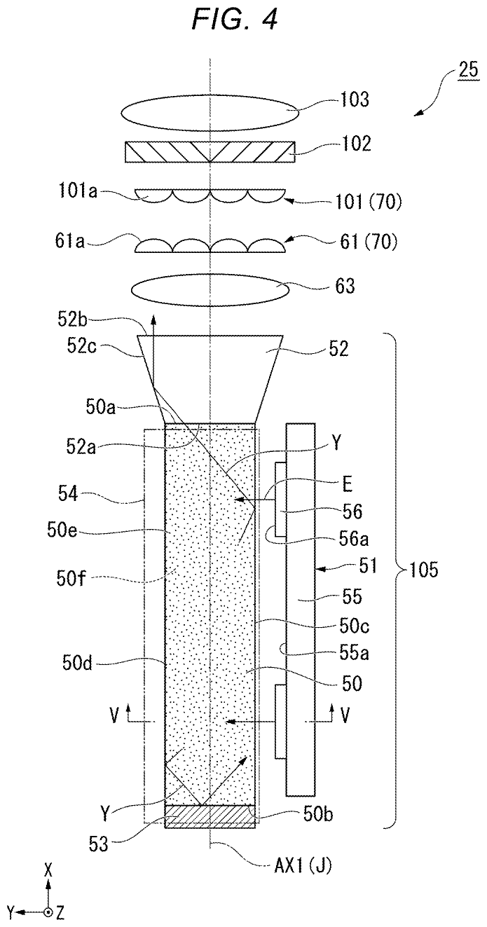

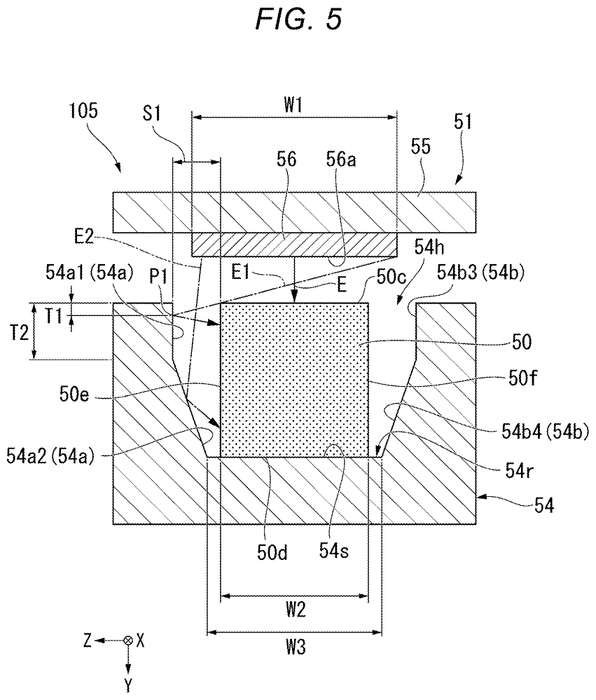

A second embodiment of the present disclosure will be described below with reference to FIGS. 4 and 5.

The basic configurations of the projector and the light source apparatus according to the second embodiment are the same as those in the first embodiment and will therefore not be described.

FIG. 4 is a schematic configuration diagram of a first illuminator 25 in the second embodiment. FIG. 5 is a cross-sectional view of a light source apparatus 105 taken along the line V-V in FIG. 4. In FIGS. 4 and 5, components common to those in the figures used in the first embodiment have the same reference characters and will not be described.

The light source apparatus 105 according to the present embodiment includes the wavelength conversion member 50, the light source section 51, the angle conversion member 52, the support member 54, and the second mirror 53, as shown in FIG. 4. The support member 54 in the present embodiment corresponds to the reflection member in the claims.

The support member 54 is provided so as to surround the circumference of the wavelength conversion member 50. The support member 54 supports the wavelength conversion member 50, and diffuses the heat generated by the wavelength conversion member 50 to dissipate the heat out of the wavelength conversion member 50. It is therefore desirable that the support member 54 be made of a material having predetermined strength and high thermal conductivity. It is desirable to use, for example, a metal such aluminum and stainless steel, in particular, an aluminum alloy such as a 6061 aluminum alloy as the material of the support member 54. Furthermore, the support member 54 functions as the reflection member that reflects the excitation light E having entered the wavelength conversion member 50.

The support member 54 has a groove 54h, which extends in the longitudinal direction of the wavelength conversion member 50 (axis-X direction), and houses the wavelength conversion member 50, as shown in FIG. 5. The support member 54, which has the groove 54h, has a U-letter-shaped cross section perpendicular to the axis-X direction. The groove 54h has a reflection surface 54s, a first wall surface 54a, and a second wall surface 54b.

The reflection surface 54s corresponds to the bottom surface of the groove 54h, and is in contact with the fourth surface 50d of the wavelength conversion member 50. The reflection surface 54s extends in parallel to the plane XZ. The first wall surface 54a corresponds to one side surface of the groove 54h, faces the fifth surface 50e of the wavelength conversion member 50, and is separate from the fifth surface 50e. The second wall surface 54b corresponds to the other side surface of the groove 54h, faces the sixth surface 50f of the wavelength conversion member 50, and is separate from the sixth surface 50f. That is, a gap S1 is provided between the first wall surface 54a and the fifth surface 50e of the wavelength conversion member 50. Another gap S1 is provided between the second wall surface 54b and the sixth surface 50f of the wavelength conversion member 50.

The first wall surface 54a includes a first section 54a1, which is located at the side close to the third surface 50c, and a second portion 54a2, which is located at the side close to the reflection surface 54s. The first section 54a1 extends in the direction perpendicular to the reflection surface 54s, that is, in parallel to the plane XY. The second section 54a2 inclines so as to approach the fifth surface 50e as extending from the side close to the first section 54a1 toward the reflection surface 54s. In other words, the distance between the fifth surface 50e and the second section 54a2 close to the reflection surface 54s is smaller than the distance between the fifth surface 50e and the second section 54a2 close to the first section 54a1.

The second wall surface 54b includes a third section 54b3, which is located at the side close to the third surface 50c, and a fourth portion 54b4, which is located at the side close to the reflection surface 54s. The third section 54b3 extends in the direction perpendicular to the reflection surface 54s, that is, in parallel to the plane XY. The fourth section 54b4 inclines so as to approach the sixth surface 50f as extending from the side close to the third section 54b3 toward the reflection surface 54s. In other words, the distance between the sixth surface 50f and the fourth section 54b4 close to the reflection surface 54s is smaller than the distance between the sixth surface 50f and the fourth section 54b4 close to the third section 54b3.

The reflection surface 54s, the first wall surface 54a, and the second wall surface 54b are each formed of a surface made, for example, of aluminum, stainless steel, or any other metal of which the support member 54 is made. More specifically, the reflection surface 54s, the first wall surface 54a, and the second wall surface 54b are each formed of a processed surface that is the metal surface described above on which mirror-finishing has been performed. The reflection surface 54s, the first wall surface 54a, and the second wall surface 54b therefore each have light reflectivity and reflect the excitation light E incident thereon. The reflection surface 54s, the first wall surface 54a, and the second wall surface 54b may each be formed of a metal film formed on the surface made of aluminum, stainless steel, or any other metal and made of metal different therefrom, or a dielectric multilayer film formed on the metal surface.

A dimension W1, along the axis-Z direction, of the light emitting surface 56a of each of the light emitters 56 is greater than a dimension W2, along the axis-Z direction, of the wavelength conversion member 50. Opposite end portions of the light emitting surface 56a of each of the light emitter 56 therefore protrude beyond the third surface 50c of the wavelength conversion member 50 in the axis-Z direction. Specifically, the opposite end portions of the light emitting surface 56a of each of the light emitters 56 protrude to positions where the opposite end portions overlap with the gap S1 between the fifth surface 50e and the first wall surface 54a and the gap S1 between the sixth surface 50f and the second wall surface 54b, respectively. In other words, when the light emitting surface 56a is viewed from the side facing the reflection surface 54s along the axis-Y direction, a portion of the light emitting surface 56a coincides with the third surface 50c, and the other portion of the light emitting surface 56a overlaps with the gap S1 between the fifth surface 50e and the first wall surface 54a and the gap S1 between the sixth surface 50f and the second wall surface 54b.

Let P1 be the position where excitation light E1 outputted from the −Z-side end of the light emitting surface 56a, passing through the +Z-side corner of the third section 50c of the wavelength conversion member 50, and traveling toward the first wall surface 54a is incident on the first wall surface 54a, and T1 be the distance from the −Y-side end of the first wall surface 54a to the position P1. Under the definition described above, a dimension T2, along the axis-Y direction, of the first section 54a1 is desirably greater than at least the distance T1.

A dimension W3, along the axis-Z direction, of the reflection surface 54s of the support member 54 is greater than the dimension W2, along the axis-Z direction, of the wavelength conversion member 50. Opposite end portions of the reflection surface 54s therefore protrude beyond the fourth surface 50d of the wavelength conversion member 50 in the axis-Z direction. In other words, when the reflection surface 54s is viewed from the side facing the light emitting surface 56a along the axis-Y direction, a portion of the reflection surface 54s coincides with the fourth surface 50d, and the other portion of the reflection surface 54s is exposed to the space outside of the fourth surface 50d. The reflection surface 54s thus has an exposed section 54r exposed to the space outside the wavelength conversion member 50.

The other configurations of the light source apparatus are the same as those of the light source apparatus according to the first embodiment.

### Effects of Second Embodiment

The light source apparatus 105 according to the present embodiment can also provide the same effects as those provided by the first embodiment, for example, the light scattering and the self-absorption in the wavelength conversion member 50 can be reduced, so that the amount of fluorescence Y that exits via the first surface 50a of the wavelength conversion member 50 can be increased, and a shift of the spectrum of the fluorescence Y can be suppressed, so that fluorescence Y having a desired color tone can be generated.

The light source apparatus 105 according to the present embodiment further includes the support member 54, which supports the wavelength conversion member 50. The support member 54 has the reflection surface 54s, which is in contact with the fourth surface 50d of the wavelength conversion member 50 and reflects the excitation light E incident via the third surface 50c.

According to the configuration described above, the wavelength conversion member 50 is supported by the support member 54, and the heat generated in the wavelength conversion member 50 is dissipated out thereof via the support member 54, so that an increase in the temperature of the wavelength conversion member 50 is suppressed. A decrease in wavelength conversion efficiency due to an increase in the temperature of the wavelength conversion member 50 is thus suppressed, whereby the amount of fluorescence Y light that exits via the first surface 50a of the wavelength conversion member 50 can be maintained in a stable manner.

In the light source apparatus 105 according to the present embodiment, the support member 54 has the groove 54h, which houses the wavelength conversion member 50. The groove 54h has the reflection surface 54s, the first wall surface 54a, which faces the fifth surface 50e, and the second wall surface 54b, which faces the sixth surface 50f. The fifth surface 50e and the first wall surface 54a are separate from each other, and the sixth surface 50f and the second wall surface 54b are separate from each other.

According to the configuration described above, the excitation light E outputted from the light emitters 56 therefore enters the wavelength conversion member 50 not only via the third surface 50c but also via the fifth surface 50e and the sixth surface 50f. As a result, the efficiency of utilization of the excitation light E can be increased, whereby a desired amount of fluorescence Y can be generated.

In the light source apparatus 100 according to the present embodiment, the first wall surface 54a has the first section 54a1, which is relatively far away from the reflection surface 54s and extends in the direction perpendicular to the reflection surface 54s, and the second section 54a2, which is relatively close to the reflection surface 54s and extends in a direction that inclines with respect to the reflection surface 54s. The second wall surface 54b has the third section 54b3, which is relatively far away from the reflection surface 54s and extends in the direction perpendicular to the reflection surface 54s, and the fourth section 54b4, which is relatively close to the reflection surface 54s and extends in the direction that inclines with respect to the reflection surface 54s. The first section 54a1, the second section 54a2, the third section 54b3, and the fourth section 54b4 reflect at least part of the excitation light E.

According to the configuration described above, excitation light E2, which is part of the excitation light E outputted via the light emitting surface 56a of each of the light emitters 56, passes through the gap between the fifth surface 50e of the wavelength conversion member 50 and the first section 54a1, and is then incident on the second section 54a2, which inclines with respect to the reflection surface 54s, as shown in FIG. 5. In this process, the excitation light E2 is reflected off the second section 54a2 and incident on the fifth surface 50e of the wavelength conversion member 50. The excitation light E2 passing through the gap between the fifth surface 50e of the wavelength conversion member 50 and the first wall surface 54a is thus likely to be incident on the fifth surface 50e, whereby the amount of excitation light E that is reflected off the reflection surface 54s and returns back toward the light source section 51 can be reduced. Furthermore, the excitation light E1 outputted from the −Z-side end of the light emitting surface 56a, passing through the +Z-side corner of the third surface 50c of the wavelength conversion member 50, and traveling toward the first wall surface 54a is reflected off the first section 54a1, which extends in the direction perpendicular to the reflection surface 54s, and is incident on the fifth surface 50e of the wavelength conversion member 50. The amount of excitation light that is reflected off the inclining first wall surface and returns toward the light source section can thus be reduced. The light source apparatus 100 according to the present embodiment can therefore use the excitation light E in a highly efficient manner and readily generate a desired amount of fluorescence Y.

The technical scope of the present disclosure is not limited to the embodiments described above, and a variety of changes can be made thereto to the extent that the changes do not depart from the intent of the present disclosure. An aspect of the present disclosure can be an appropriate combination of the characteristic portions in the embodiments described above.

In the second embodiment, the wall surfaces of the groove of the support member each have a portion perpendicular to the reflection surface and a portion inclining with respect to the reflection surface, but the groove does not necessarily have a specific shape. For example, all regions of each of the wall surfaces of the groove may instead be perpendicular to the reflection surface. Still instead, the wall surfaces of the groove may be curved.

The wavelength conversion member is not necessarily limited to a wavelength conversion member that converts light having the blue wavelength band into light having the yellow wavelength band, and may instead handle light having other wavelength bands.

In addition, the specific descriptions of the shape, the number, the arrangement, the materials, and other factors of the components of the light source apparatus and the projector are not limited to those in the embodiments described above and can be changed as appropriate. The aforementioned embodiments have been described with reference to the case where the light source apparatus according to the present disclosure is incorporated in a projector using liquid crystal panels, but not necessarily. The light source apparatus according to the present disclosure may be incorporated in a projector using a digital micromirror device as each of the light modulators. The projector may not include a plurality of light modulators and may instead include only one light modulator.

The aforementioned embodiments have been described with reference to the case where the light source apparatus according to the present disclosure is incorporated in a projector, but not necessarily. The light source apparatus according to the present disclosure may be used as a lighting apparatus, a headlight of an automobile, and other components.

A light source apparatus according to an aspect of the present disclosure may have the configuration below.

The light source apparatus according to the aspect of the present disclosure includes a light emitter that outputs first light having a first wavelength band, a wavelength conversion member that contains a phosphor and converts the first light outputted from the light emitter into second light having a second wavelength band different from the first wavelength band, and a reflection member that reflects the first light having entered the wavelength conversion member. The wavelength conversion member has a first surface and a second surface located at the sides opposite from each other in a first direction, and a third surface and a fourth surface located at the sides opposite from each other in a second direction that intersects with the first direction. The second light exits via the first surface. The first light outputted from the light emitter enters the wavelength conversion member via the third surface. The reflection member is provided so as to face the fourth surface. An activator contained in the phosphor has a concentration required to absorb the first light by an amount smaller than 98% of the amount of the incident first light in the path along which the first light incident via the third surface travels to the fourth surface.

In the light source apparatus according to the aspect of the present disclosure, the activator contained in the phosphor may have a concentration required to absorb the first light by an amount greater than 30% of the amount of the incident first light in the path along which the first light incident via the third surface travels to the fourth surface.

In the light source apparatus according to the aspect of the present disclosure, the reflection member may have a reflectance greater than or equal to 75%.

In the light source apparatus according to the aspect of the present disclosure, the reflection member may have a reflectance greater than or equal to 90%.

In the light source apparatus according to the aspect of the present disclosure, the activator may have a concentration required to absorb the first light by an amount smaller than or equal to 92% but greater than or equal to 40% of the amount of the incident first light in the path.

In the light source apparatus according to the aspect of the present disclosure, the reflection member may be formed of a support member that supports the wavelength conversion member, and the support member may have a reflection surface that is in contact with the fourth surface and reflects the first light incident via the third surface.

In the light source apparatus according to the aspect of the present disclosure, the wavelength conversion member may further have a fifth surface and a sixth surface located at the sides opposite from each other in a third direction that intersects with the first and second directions. The support member may further include a groove that houses the wavelength conversion member. The groove may have the reflection surface, a first wall surface that faces the fifth surface and is separate from the fifth surface, a second wall surface that faces the sixth surface and is separate from the sixth surface.

In the light source apparatus according to the aspect of the present disclosure, the first wall surface may include a first section located at the side close to the third surface, and a second section located at the side close to the reflection surface. The first section may extend in the direction perpendicular to the reflection surface. The second section may incline so as to approach the fifth surface as extending from the side close to the first section toward the reflection surface. The second wall surface may include a third section located at the side close to the third surface, and a fourth section located at the side close to the reflection surface. The third section may extend in the direction perpendicular to the reflection surface. The fourth section may incline so as to approach the sixth surface as extending from the side close to the third section toward the reflection surface. The first, second, third, and fourth sections may reflect at least part of the light.

A projector according to another aspect of the present disclosure may have the configuration below.

The projector according to the other aspect of the present disclosure includes the light source apparatus according to the aspect of the present disclosure, a light modulator that modulates the light outputted from the light source apparatus and containing the second light in accordance with image information, and a projection optical apparatus that projects the light modulated by the light modulator.

What is claimed is:

1. A light source apparatus comprising:
a light emitter that outputs first light having a first wavelength band;
a wavelength conversion member that contains a phosphor and converts the first light outputted from the light emitter into second light having a second wavelength band different from the first wavelength band; and
a reflection member that reflects the first light that enters the wavelength conversion member,
wherein the wavelength conversion member has a first surface and a second surface located at sides opposite from each other in a first direction, and a third surface and a fourth surface located at sides opposite from each other in a second direction that intersects with the first direction,
the second light exits via the first surface,
the first light outputted from the light emitter enters the wavelength conversion member via the third surface,
the reflection member is provided so as to face the fourth surface, and
an activator contained in the phosphor has a concentration required to absorb the first light by an amount smaller than 98% of an amount of the incident first light in a path along which the first light incident via the third surface travels to the fourth surface.

2. The light source apparatus according to claim 1, wherein the activator contained in the phosphor has a concentration required to absorb the first light by an amount greater than 30% of the amount of the incident first light in the path along which the first light incident via the third surface travels to the fourth surface.

3. The light source apparatus according to claim 1, wherein the reflection member has a reflectance greater than or equal to 75%.

4. The light source apparatus according to claim 3, wherein the reflection member has a reflectance greater than or equal to 90%.

5. The light source apparatus according to claim 1, wherein the activator has a concentration required to absorb the first light by an amount smaller than or equal to 92% but greater than or equal to 40% of the amount of the incident first light in the path.

6. The light source apparatus according to claim 1,
wherein the reflection member is formed of a support member that supports the wavelength conversion member, and
the support member has a reflection surface that is in contact with the fourth surface and reflects the first light incident via the third surface.

7. The light source apparatus according to claim 6,
wherein the wavelength conversion member further has a fifth surface and a sixth surface located at sides opposite from each other in a third direction that intersects with the first and second directions,
the support member further includes a groove that houses the wavelength conversion member, and
the groove has the reflection surface, a first wall surface that faces the fifth surface and is separate from the fifth surface, a second wall surface that faces the sixth surface and is separate from the sixth surface.

8. The light source apparatus according to claim 7,
wherein the first wall surface includes a first section located at a side close to the third surface, and a second section located at a side close to the reflection surface, the first section extending in a direction perpendicular to the reflection surface, the second section inclining so as to approach the fifth surface as extending from a side close to the first section toward the reflection surface,
the second wall surface includes a third section located at the side close to the third surface, and a fourth section located at the side close to the reflection surface, the third section extending in the direction perpendicular to the reflection surface, the fourth section inclining so as to approach the sixth surface as extending from the side close to the third section toward the reflection surface, and
the first, second, third, and fourth sections reflect at least part of the light.

9. A projector comprising:
the light source apparatus according to claim 1;
a light modulator that modulates light outputted from the light source apparatus and containing the second light in accordance with image information; and
a projection optical apparatus that projects the light modulated by the light modulator.
